(19) United States
(12) Patent Application Publication
(10) Pub. No.: US 2007/0155230 A1
(43) Pub. Date: Jul. 5, 2007

(54) Coaxial cable connector, and harness unit that utilizes the coaxial cable connector

(76) Inventors: Yoshihisa Kawate, Kanagawa (JP); Hiroyuki Matsuoka, Kanagawa (JP)

Correspondence Address: 3M INNOVATIVE PROPERTIES COMPANY, PO BOX 33427, ST. PAUL, MN, 55133-3427, US

(21) Appl. No.: 10/549,960

(22) PCT Filed: Mar. 16, 2004
(86) PCT No.: PCT/US04/08104

§ 371 Date: Oct. 20, 2005

(30) Foreign Application Priority Data
Apr. 10, 2003 (JP) 2003-106832

(51) Int. Cl. H01R 9/05

(52) U.S. Cl. 439/578

(57) ABSTRACT

A coaxial cable connector can be easily fitted to one or a plurality of coaxial cables, and that can secure an independent shield. Inner insulator exposed portions and outer conductor exposed portions of coaxial cables are matched with a first cable holder. A second cable holder is reversed on the first cable holder, and is engaged therewith. The engagement is further engaged with a housing. Central conductors of the inner insulator exposed portions are engaged with cuts of first contact elements. The outer conductor exposed portions are held in gripping conductors that are disposed inside the first cable holder. Gripping conductor extensions that are coupled with the gripping conductors are engaged with cuts of second contact elements. The contact elements are connected to external cable connection terminals that extend within a connection chamber of the housing.

### DETAILED DESCRIPTION OF THE INVENTION

1. Technical Field to which the Invention Belongs

The present invention relates to a coaxial cable connector that connects a coaxial cable, and a harness unit that uses the coaxial cable connector.

Prior Art

A coaxial cable comprising a central conductor, an inner insulating member that surrounds the central conductor, an outer conductor that surrounds the inner insulating member for shielding the central conductor, and an outer insulating member that surrounds the outer conductor has been used in various fields. For example, the coaxial cable is used to connect various kinds of measuring apparatuses in research organizations, and is used to connect electronic appliances at home.

In order to connect this coaxial cable with various kinds of apparatuses, or other coaxial cables, what is called a BNC connector is used. The BNC connector comprises an inner member that is connected to the coaxial cable, and an outer ring that is rotatably fitted to the outside of the inner member and has slanted notches to be engaged with an external terminal.

When the BNC connector is used, at the front end of the coaxial cable, a central conductor exposed portion with a predetermined length is formed, in which only the central conductor is left and the inner insulating member, the outer conductor, and the outer insulating member at the outside of the central conductor are removed from the surface. Further, an outer conductor exposed portion with a predetermined length is formed continuing from the rear end of the central conductor exposed portion, in which the central conductor, the inner insulating member, and the outer conductor are left and only the external insulating member is removed from the surface.

A central terminal of the BNC connector is pressed against the central conductor of the full peel-off portion. While the central terminal is inserted into a coaxial cable connection cylinder at the rear end of the inner member of the BNC connector, the outer conductor of the outer conductor exposed portion is disentangled, and this disentangled portion is roughly covered on the outside of the cylinder. Thereafter, a caulking member set in advance on an original diameter portion is moved, and the front end of the caulking member is covered on the outside of the disentangled outer conductor. The rear end is crushed, and is bitten into the original diameter portion. Thus, a complex work is necessary. The BNC connector can be connected to only one coaxial cable.

Coaxial connector cables that can be combined with a plurality of coaxial cables are disclosed in a patent literature 1 (Japanese Patent Application Laid-open Publication No. 5-135825), and a patent literature 2 (Japanese Utility Model Application Laid-open Publication No. 4-14858). While these coaxial cable connectors can connect a plurality of coaxial cables, each coaxial cable connector requires a soldering of a outer conductor to a cable supporting member. Consequently, the outer conductors of a plurality of coaxial cables are integrally combined, and are made electrically common. As a result, when a shield of one coaxial cable is degraded, the shields of all the other coaxial cables are also degraded.

[Patent literature 1]

Japanese Patent Application Laid-open Publication No. 5-135825

[Patent literature 2]

Japanese Utility Model Application Laid-open Publication No. 4-14858

### PROBLEMS TO BE SOLVED BY THE INVENTION

It is an object of the present invention to provide a coaxial cable connector that can be easily fitted to one or a plurality of coaxial cables, and that can secure an independent shield.

### MEANS FOR SOLVING THE PROBLEMS

In one embodiment according to the invention, there is provided a coaxial cable connector comprising,

a first cable holder,

a second cable holder which can be engaged to said first cable holder by pressing,

a housing to which an assembly by engaging said first cable holder and said second cable holder,

at least one gripping conductors and gripping conductor extensions extending therefrom which are located in said first cable holder in an insulated condition, and,

a plurality of contact elements and external cable connection terminals connected thereto which are located in said housing in an insulated condition,

wherein,

each cable holder has grooves for receiving an inner insulator exposed portion and an outer conductor exposed portion of the coaxial cable formed at one end thereof,

said gripping conductors each grips said outer conductor exposed portion of the coaxial cable,

said gripping conductor extensions each engages with a corresponding contact element, and a central conductor of the coaxial cable in the outer conductor exposed portion engages with a corresponding contact element.

According to the coaxial cable connector having the above structure, it is possible to easily fit the coaxial cable by engagement based on pressing, and the central conductor and the outer conductor of the coaxial cable are connected to external cable connection terminal in an insulated condition. Therefore, even when a plurality of coaxial cables are fitted, it is possible to separately secure individual shieldings.

In another embodiment according to the invention, said first cable holder comprises:

a block body;

at least one first inner insulator exposed portion receiving grooves that is formed on a first surface of the block body and receives approximately half of a cross-sectional portion of the inner insulator exposed portion of the coaxial cable;

at least one first outer conductor exposed portion receiving grooves that is formed to continue from a rear end of the first inner insulator exposed portion receiving groove and receives approximately half of a cross-sectional portion of the outer conductor exposed portion of the coaxial cable;

at least one first original-diameter end portion receiving grooves that is formed to continue from a rear end of the first outer conductor exposed portion receiving groove, and receives approximately half of a cross-sectional portion of an original-diameter end portion;

wherein, said gripping conductor is disposed in the first outer conductor exposed portion receiving groove, and said gripping conductor extension extends from said gripping conductor to a direction of the front end of the coaxial cable in parallel with the first outer conductor exposed portion receiving groove,

said second cable holder comprises:

a block body;

at least one second inner insulator exposed portion receiving grooves equal in number to the number of the first inner insulator exposed portion receiving groove of the first cable holder, that is formed on a first surface of the block body and receives approximately half of a cross-sectional portion of the inner insulator exposed portion of the coaxial cable;

at least one second outer conductor exposed portion receiving grooves that is formed to continue from a rear end of the second inner insulator exposed portion receiving groove and receives approximately half of a cross-sectional portion of the outer conductor exposed portion of the coaxial cable; and

at least one second original-diameter end portion receiving grooves that is formed to continue from a rear end of the second outer conductor exposed portion receiving groove, and receives approximately half of a cross-sectional portion of the original diameter portion of the coaxial cable,

wherein, after positioning the outer conductor exposed portion of the coaxial cable to be matched with a position of the gripping conductor of the first cable holder, the first surface of the first cable holder being pressed against the first surface of the second cable holder to face each other so that they are engaged with each other and the second outer conductor exposed portion receiving groove presses the gripping conductor in deformation and thereby grip the outer conductor exposed portion of the coaxial cable, said housing comprises:

a block body, to which said assembly by engaging said first cable holder and said second cable holder are engaged by pressing;

at least one first contact elements equal in number to the number of the first inner insulator exposed portion receiving groove of the first cable holder, mounted on a first surface of the block body and is capable of engaging with the central conductor of the inner insulator exposed portion of the coaxial cable at the engagement time; and

at least one second contact elements equal in number to the number of the first inner insulator exposed portion receiving groove of the first cable holder, mounted on the first surface of the block body and is capable of engaging with the gripping conductor extension that is disposed on the first cable holder upon engagement,

wherein, said first contact element being connected to an insulated external cable connection terminal for the central conductor via an insulated connection member for said first contact element, and said second contact element being connected to an insulated external cable connection terminal for the outer conductor via an insulated connection member for said second contact element,

wherein said first cable holder and said second cable holder are fitted with complementary engaging units respectively for mutually engaging the two cable holders, and at least one of the first cable holder and the second cable holder, and the housing are provided with complementary engaging units respectively for mutually engaging the cable holder assembly and the housing.

In another embodiment according to the invention, the first contact element and the second contact element have cuts formed on plate members that are mounted on the block body of the housing respectively.

In another embodiment according to the invention, the gripping conductor extension has projections that stretch perpendicularly in a longitudinal direction, and the projections are engaged with holes formed on the first cable holder, and are held at predetermined positions.

In another embodiment according to the invention, the gripping conductor has projections that stretch perpendicularly in a longitudinal direction, and the projections are engaged with holes formed on the first cable holder, and are held at predetermined positions.

In another embodiment according to the invention, the gripping conductor has a pressed portion that is pressed and deformed, and a base portion to which one side of the pressed portion is integrally connected, the gripping conductor extension is connected to a first end of the base portion near the front end of the coaxial cable, and staged projections that bite into the original-diameter end portion and are capable of gripping the original-diameter portion are formed on a second end of the base portion far from the front end of the coaxial cable.

In another embodiment according to the invention, a coaxial cable harness unit is formed by using any one of the embodiments of the coaxial cable connectors.

### Embodiments of the Invention

Embodiments of the present invention will be explained below with reference to the accompanying drawings.

FIG. 1 is a perspective view that shows a state before a coaxial cable connector 1 according to the present invention fits coaxial cables. The coaxial cable connector 1 can fit two coaxial cables. The coaxial cable connector 1 includes a first cable holder 100, a second cable holder 200, and a housing 300 that are formed by using an insulating resin material respectively. The first cable holder 100 and the second cable holder 200 are coupled together with two flexible and foldable coupling members 2. The second cable holder 200 and the housing 300 are also coupled together with two flexible and foldable coupling members 3.

A reference symbol 101 denotes a block body of the first cable holder 100, a reference symbol 201 denotes a block body of the second cable holder 200, and a reference symbol 301 denotes a block body of the housing 300. The side in which outgoing lines for reference symbols are provided, that is, the upper side in FIG. 1, will be called a front end. The opposite side, that is, the lower side in FIG. 1, will be called a rear end.

The upward-facing surfaces of the block body 101 of the first cable holder 100, the block body 201 of the second cable holder 200, and the block body 301 of the housing 300 will be called first surfaces respectively. The opposite surfaces will be called second surfaces. Reference symbols of these surfaces are omitted.

FIG. 2 shows a processing state of the front ends of two coaxial cables 10a and 10b respectively that are fitted to the coaxial cable connector 1. The coaxial cables 10a and 10b comprise central conductors 11a and 11b, inner insulating members 12a and 12b that surround the outside of the central conductors 11a and 11b, outer conductors 13a and 13b that surround the outside of the inner insulating members 12a and 12b, and external insulating members 14 and 14b that surround the outside of the outer conductors 13a and 13b, respectively.

Each of the central conductors 11a and 11b is made of one conductor. In the present embodiment, the outer conductors 13a and 13b are mesh conductors. It is also possible to form the outer conductors 13a and 13b by using a lateral winding conductor, a metal pipe, metal foil, a metal-deposited film, or the like.

Inner insulator exposed portions 15a and 15b that have the outer insulating members 14a and 14b peel-off from the surface respectively are formed to have a predetermined length L1 from the front end. Outer conductor exposed portions 16a and 16b that have only the outer insulating members 14a and 14b peel-off from the surface respectively are formed to continue from the rear end of the inner insulator exposed portions 15a and 15b, to have a predetermined length L2. Portions having the original diameters that have none of the portions of the coaxial cables 10a 10b peel-off and continue from the rear end of the outer conductor exposed portions 16a and 16b are called original-diameter end portions 17a and 17b respectively.

Referring back to FIG. 1, details of the first cable holder 100 will be explained. The first cable holder 100 is formed with first inner insulator exposed portion receiving grooves 110a and 110b that receive approximately half of the cross-sectional portion of the inner insulator exposed portions 15a and 15b of the coaxial cables 10a and 10b respectively. The first cable holder 100 is further formed with first outer conductor exposed portion receiving grooves 120a and 120b that continue from the rear end of the first inner insulator exposed portion receiving grooves 110a and 110b, and receive approximately half of the cross-sectional portion of the outer conductor exposed portions 16a and 16b of the coaxial cables 10a and 10b respectively. The first cable holder 100 is further formed with first original-diameter end portion receiving grooves 130a and 130b that continue from the rear end of the first outer conductor exposed portion receiving grooves 120a and 120b, and receive approximately half of the cross-sectional portion of the original-diameter end portions 17a and 17b of the coaxial cables 10a and 10b respectively.

Each of the first inner insulator exposed portion receiving grooves 110a and 110b has a length approximately equal to the length L1 shown in FIG. 2. Each of the first outer conductor exposed portion receiving grooves 120a and 120b has a length approximately equal to the length L2 shown in FIG. 2.

Each of the first inner insulator exposed portion receiving grooves 11a and 11b has an approximately arcuate cross section. The front end of each of the first inner insulator exposed portion receiving grooves 110a and 110b is closed with a front end wall 102. At positions near the front end wall 102, confirmation holes 111a and 111b are formed on the bottoms of the grooves to pierce through the second surface side. An operator can confirm through these confirmation holes 111a and 111b whether the coaxial cables 10a and 10b are disposed at predetermined positions such that the front ends of the inner insulator exposed portions 15a and 15b are brought into contact with the front end wall 102 respectively.

Further, there are formed first contact element through-holes 112a and 112b through which first contact elements 330a and 330b that are fitted on the housing 300 pass when a cable holder assembly 400 (refer to FIG. 5), which is an engagement of the first cable holder 100 and the second cable holder 200, is engaged with the housing 300.

Next, details of the first outer conductor exposed portion receiving grooves 120a and 120b will be explained. Each of the first outer conductor exposed portion receiving grooves 120a and 120b has a U-shaped cross section on a flat bottom. Gripping conductors 140a and 140b that grip the outer conductor exposed portions 16a and 16b of the coaxial cables 10a and 10b respectively are disposed on the first outer conductor exposed portion receiving grooves 120a and 120b. Gripping conductor extensions 150a and 150b are integrally connected to the front end of the gripping conductors 140a and 140b, and extend to the front end respectively. The gripping conductor extensions 150a and 150b are disposed in gripping conductor extension receiving grooves 160a and 160b that are formed on the first surface of the block body 101 between the two first inner insulator exposed portion receiving grooves 110a and 110b.

Further, there are formed second contact element through-holes 161a and 161b through which second contact elements 340a and 340b that are fitted on the housing 300 pass when the cable holder assembly 400 (refer to FIG. 5), which is the engagement of the first cable holder 100 and the second cable holder 200, is engaged with the housing 300, such that the second contact element through-holes 161a and 161b are orthogonal with the gripping conductor extension receiving grooves 160a and 160b respectively.

FIG. 3 shows the gripping conductors 140a and 140b, and the gripping conductor extensions 150a and 150b that are integrally fitted to them. The gripping conductors 140a and 140b have pressed portions 141a and 141b that are pressed and deformed when the first cable holder 100 and the second cable holder 200 are engaged together, and base portions 142a and 142b that are connected to one side of the pressed portions 141a and 141b respectively and are mounted on the bottoms of the first outer conductor exposed portion receiving grooves 120a and 120b.

Projections 143a and 143b are fitted on the base portions 142a and 142b, and projections 151a and 151b are fitted on the gripping conductor extensions 150a and 150b, respectively. These projections are engaged with corresponding holes (not shown) that are formed on the block body 110, so that the gripping conductors 140a and 140b and the gripping conductor extensions 150a and 150b are set at predetermined positions.

Staged projections 144a and 144b are formed on the ends of the rear end of the base portions 142a and 142b respectively. At the time of engaging the first cable holder 100 and the second cable holder 200 together, the projections 144a and 144b bite into the original-diameter end portions 17a and 17b of the coaxial cables 10a and 10b, and grip the original-diameter end portions 17a and 17b.

Referring back to FIG. 1, the details of the first original-diameter end portion receiving grooves 130a and 130b will be explained. The first original-diameter end portion receiving grooves 130a and 130b have approximately arc-shaped cross sections respectively. Bottom projections 131a and 131b are provided on the bottoms of the first original-diameter end portion receiving grooves 130a and 130b respectively. First side projections 132a and 132b and second side projections 133a and 133b are formed at upper ends of mutually opposite side walls. These projections have a function of biting into the original-diameter end portions 17a and 17b of the coaxial cables 10a and 10b and gripping the original-diameter end portions 17a and 17b, at the time of engaging the first cable holder 100 and the second cable holder 200 together. The first side projections 132a and 132b and the second side projections 133a and 133b also have a function of temporarily fixing the coaxial cables 10a and 10b thereby to prevent them from moving at a first setting of the coaxial cables.

First projections 103a and 103b and second projections 104a and 104b (not shown in FIG. 1) are formed on the external sides of the first inner insulator exposed portion receiving grooves 110a and 110b respectively, and third projections 105a and 105b are formed on the upper sides respectively. Fourth projections 106a and 106b and fifth projections 107a and 107b are formed on the external sides of the original-diameter end portion receiving grooves 130a and 130b respectively.

Next, details of the second cable holder 200 will be explained.

The second cable holder 200 is formed with second inner insulator exposed portion receiving grooves 210a and 210b that receive approximately the remaining half of the cross-sectional portion of the inner insulator exposed portions 15a and 15b of the coaxial cables 10a and 10b respectively. The second cable holder 200 is further formed with second outer conductor exposed portion receiving grooves 220a and 220b that continue from the rear end of the second inner insulator exposed portion receiving grooves 210a and 210b, and receive approximately the remaining half of the cross-sectional portion of the outer conductor exposed portions 16a and 16b of the coaxial cables 10a and 10b respectively. The first cable holder 200 is further formed with second original-diameter end portion receiving grooves 230a and 230b that continue from the rear end of the second outer conductor exposed portion receiving grooves 220a and 220b, and receive approximately the remaining half of the cross-sectional portion of the original-diameter end portions 17a and 17b of the coaxial cables 10a and 10b respectively.

Each of the second inner insulator exposed portion receiving grooves 210a and 210b has a length approximately equal to the length L1 shown in FIG. 2. Each of the second outer conductor exposed portion receiving grooves 220a and 220b has a length approximately equal to the length L2 shown in FIG. 2.

The second cable holder 200 is reversed such that the first surface thereof is brought into contact with the first surface of the first cable holder 100, and the second cable holder 200 is engaged with the first cable holder 100. Therefore, in FIG. 1, reference symbols that have “aa” are shown at the right side, and reference symbols that have “b” are shown at the left side, opposite to those of the first cable holder 100.

Each of the second inner insulator exposed portion receiving grooves 210a and 210b has an approximately arcuate cross section. The front end of each of the second inner insulator exposed portion receiving grooves 210a and 210b is closed with front end walls 202a and 202b respectively. At positions near the front end walls 202a and 202b, confirmation holes 211a and 211b are formed on the bottoms of the grooves to pierce through the second surface side. An operator can also confirm through these confirmation holes 211a and 211b whether the coaxial cables 10a and 10b are disposed at predetermined positions such that the front ends of the inner insulator exposed portions 15a and 15b are brought into contact with the front end walls 202a and 202b respectively.

There are formed first contact element through-holes 212a and 212b through which first contact elements 330a and 330b that are fitted on the housing 300 pass when the cable holder assembly (refer to FIG. 5), which is the engagement of the first cable holder 100 and the second cable holder 200, is engaged with the housing 300.

Further, between the two second inner insulator exposed portion receiving grooves 210 and 210b, there are formed second contact element through-holes 250a and 250b through which the second contact elements 340a and 340b that are fitted on the housing 300 pass when the cable holder assembly (refer to FIG. 5), which is the engagement of the first cable holder 100 and the second cable holder 200, is engaged with the housing 300.

Each of the second outer conductor exposed portion receiving grooves 220a and 220b has basically a cross section of approximately an arcuate shape. The second outer conductor exposed portion receiving grooves 220a and 220b further have clearance grooves 221a and 221b respectively so that the pressed portions 141a and 141b of the gripping conductors 140a and 140b can suitably bend at the time of engaging the first cable holder 100 and the second cable holder 200 together.

The second original-diameter end portion receiving grooves 230a and 230b have approximately arc-shaped cross sections respectively. Bottom projections 231a and 231b are provided on the bottoms of the second original-diameter end portion receiving grooves 230a and 230b respectively. These projections have a function of biting into the original-diameter end portions 17a and 17b of the coaxial cables 10a and 10b and gripping the original-diameter end portions 17a and 17b, at the time of engaging the first cable holder 100 and the second cable holder 200 together.

First projections 203a (not shown in FIG. 1) and 203b, second projections 204a (not shown in FIG. 1) and 204b, third projections 205a and 205b, and cuts 206a and 206b are formed on the external sides of the second inner insulator exposed portion receiving grooves 210a and 210b of the second cable holder 200 respectively.

L-shaped first arms 241a and 241b, second arms 242a and 242b, and third arms 243a and 243b are provided on the external sides of the second outer conductor exposed portion receiving grooves 220a and 220b and the second original-diameter end portion receiving grooves 230a and 230b respectively. The front ends of these arms cross-linked with bars 244a and 244b respectively. The first arms 241a and 241b are provided with fourth projections 207a (not shown in FIG. 1) and 207b respectively. The bars 244a and 244b are provided with fifth projections 208a (not shown in FIG. 1) and 208b respectively.

Details of the housing 300 will be explained next.

A first chamber 310 is provided at the front end, and a second chamber 320 is provided at the rear end, of the block body 301 of the housing 300 respectively.

The first contact elements 330a and 330b and the second contact elements 340a and 340b are fitted within the first chamber 310. A method of fitting the contact elements will be explained below.

FIG. 4 is a perspective view of the first contact elements 330a and 330b and the second contact elements 340a and 340b. First contact element connection members 350a and 350b and second contact element connection members 360a and 360b are fitted to the lower ends of the first contact elements 330a and 330b and the second contact elements 340a and 340b respectively. The first contact element connection members 350a and 350b and the second contact element connection members 360a and 360b extend to the front end, and their front ends are bent upward respectively. External cable connecting terminals 370a, 370b, 380a, and 380b are fitted to the front ends of these connection members.

The first contact elements 330a and 330b and the second contact elements 340a and 340b are engaged with grooves 311a, 311b, 312a, and 312b that are formed on the bottom of the first chamber 310 respectively. The external cable connection terminals 370a, 370b, 380a, and 380b pass through holes (not shown) formed in advance on an end wall 302 of the block body 301, and reach a connection chamber (not shown) into which other connectors formed at the front end of the end wall 302 are inserted. The first contact elements 330a and 330b and the second contact elements 340a and 340b are positioned and their postures are held in this way.

The first contact elements 330a and 330b and the second contact elements 340a and 340b are formed with cuts 332a, 332b, 342a, and 342b that lead toward the bottom of the block body 301 from the upper end in the drawing, on plate members 331a, 331b, 341a, and 341b respectively. Thin acuminate cutting edges 333a, 333b, 343a, and 343b are formed at the upper ends of the plate members 331a, 331b, 341a, and 341b respectively.

The first contact elements 330a and 330b and the second contact elements 340a and 340b are mutually the same, and the external cable connection terminals 370a, 370b, 380a, and 380b are also mutually the same. However, the first contact element connection members 350a and 350b and the second contact element connection members 360a and 360b have mutually different lengths as shown in the drawing, and the short connection members and the long connection members are alternately arranged. With this arrangement, it is possible to narrow the width while preventing the occurrence of a short-circuiting.

On the side wall of the first chamber 310, there are formed first grooves 303a and 303b (not shown in FIG. 1) of which upper sides are closed in the drawing, second grooves 304a and 304b (not shown in FIG. 1) of which upper sides are opened in the drawing, and third grooves 305a and 305b (not shown in FIG. 1) of which upper sides are closed in the drawing, respectively.

On the side wall of the second chamber 320, there are formed fourth grooves 307a and 307b of which upper sides are opened in the drawing, and fifth grooves 308a and 308b (not shown in FIG. 1) of which upper sides are closed in the drawing, respectively. First bottom projections 321a and 321b and second bottom projections 322a and 322b are formed on the bottom wall of the second chamber 320 respectively. Large cuts 306a and 306b are formed to separate the first chamber 310 from the second chamber 320.

A process of connecting the coaxial cables 10a and 10b to the coaxial cable connector 1 that has the first cable holder 100, the second cable holder 200, and the housing 300 that are formed as explained above will be explained next.

First, the inner insulator exposed portions 15a and 15b and the outer conductor exposed portions 16a and 16b of the coaxial cables 10a and 10b prepared as shown in FIG. 2 are pressed into the first inner insulator exposed portion receiving grooves 110a and 110b and the first outer conductor exposed portion receiving grooves 120a and 120b of the first cable holder 100 respectively to match each other, and are set.

At this time, the first side projections 132a and 132b and the second side projections 133a and 133b within the first original-diameter end portion receiving grooves 130a and 130b of the first cable holder 100 bite into the original-diameter end portions 17a and 17b of the coaxial cables 10a and 10b respectively. Therefore, these projections are fixed temporarily, and the coaxial cables 10a and 10b are not removed.

Next, the second cable holder 200 is reversed, and is covered on the first cable holder 100.

Then, while the bars 244a and 244b of the second cable holder 200 are expanded in a width direction, these bars slide down along the external sides of the fourth projections 106a and 106b and the fifth projections 107a and 107b of the first cable holder 100 respectively. The bars 244a and 244b enter the lower side of the fourth projections 106a and 106b and the fifth projections 107a and 107b of the first cable holder 100 in FIG. 1, and the engagement is completed.

In the state that the engagement is completed, the projections 131a and 131b of the first original-diameter end portion receiving grooves 130a and 130b of the first cable holder 100, and the projections 231a and 231b of the second original-diameter end portion receiving grooves 230a and 230b of the second cable holder 200 bite into the original-diameter end portions 17a and 17b of the coaxial cables 10a and 10b respectively. Consequently, the coaxial cables 10a and 10b are held strongly.

FIG. 5 shows a state that the first cable holder 100 and the second cable holder 200 have been engaged together in the manner as described above.

The engagement of the first cable holder 100 and the second cable holder 200 is called, a cable holder assembly 400.

Next, the cable holder assembly 400 is engaged with the housing 300.

The cable holder assembly 400 shown in FIG. 5 is reversed, and is engaged with the housing 300. In other words, the second cable holder 200 becomes beneath the housing 300, and is pressed into the housing 300.

First, the third projections 105a and 105b of the first cable holder 100 are temporarily engaged with the third grooves 305a and 305b of the housing 300 respectively.

Then, the first projections 203a and 203b, the second projections 204a and 204b, and the third projections 205a and 205b of the second cable holder 200 are engaged with the first grooves 303a and 303b, the second grooves 304a and 304b, and the third grooves 305a and 305b of the housing 300 respectively.

Among the above, the second projections 204a and 204b of the second cable holder 200, and the second grooves 304a and 304b of the housing 300 play the role of positioning elements.

Next, the first projections 103a and 103b and the second projections 104a and 104b of the first cable holder 100 are engaged with the first grooves 305a and 305b of the housing 300, following the first projections 203a and 203b and the third projections 205a and 205b of the second cable holder 200.

The first projections 203a and 203b and the third projections 205a and 205b of the second cable holder 200 are at the position of the same longitudinal direction as that of the first projections 103a and 103b and the second projections 104a and 104b of the first cable holder 100. Therefore, the first projections 203a and 203b and the third projections 205a and 205b of the second cable holder 200 achieve a second temporarily fixing work, following the temporarily fixing based on the third projections 105a and 105b of the first cable holder 100. Therefore, substantial engagement is effected between the first projections 103a and 103b and the second projections 104a and 104b of the first cable holder 100, and the first grooves 303a and 303b, and the third grooves 305a and 305b of the housing 300 respectively.

The third grooves 305a and 305b have large widths in a longitudinal direction so that both the third projections 105a and 105b of the first cable holder 100 and the third projections 205a and 205b of the second cable holder 200 are engaged with these groves.

At the same time, the fourth projections 207a and 207b of the second cable holder 200 are engaged with the fourth grooves 307a and 307b of the housing 300, thereby to carry out the positioning. The fifth projections 208a and 208b are engaged with the fifth grooves 308a and 308b of the housing 300 respectively.

The first bottom projections 321a and 321b and the second bottom projections 322a and 322b are formed on the bottom wall of the second chamber 320 such that these projections are engaged with the concavities formed between the first arms 241a and 241b and the second arms 142a and 242b, and with the concavities formed between the second arms 142a and 242b and the third arms 243a and 243b respectively.

The first contact element 330a passes though the first contact element through-hole 212a formed on the second inner insulator exposed portion receiving groove 210a of the second cable holder 200, and the first contact element through-hole 112a formed on the first inner insulator exposed portion receiving groove 110a of the first cable holder 100 respectively. At this time, the cutting edge 333a of the first contact element 330a cuts through the inner insulating member 12a of the inner insulator exposed portion 15a of the coaxial cable 10a, and the central conductor 11a is engaged with the cut 332a.

Similarly, the first contact element 330b passes though the first contact element through-hole 212b formed on the second inner insulator exposed portion receiving groove 210b of the second cable holder 200, and the first contact element through-hole 112b formed on the first inner insulator exposed portion receiving groove 110b of the first cable holder 100 respectively. At this time, the cutting edge 333b of the first contact element 330b cuts through the inner insulating member 12b of the inner insulator exposed portion 15b of the coaxial cable 10b, and the central conductor 11b is engaged with the cut 332b.

The second contact element 340a passes though the second contact element through-hole 250a formed on the second inner insulator exposed portion receiving groove 210a of the second cable holder 200, and the second contact element through-hole 161a formed on the first inner insulator exposed portion receiving groove 110a of the first cable holder 100. At this time, the gripping conductor extension 150a is engaged with the cut 342a of the second contact element 340a.

Similarly, the second contact element 340b passes though the second contact element through-hole 250b formed on the second inner insulator exposed portion receiving groove 210b of the second cable holder 200, and the second contact element through-hole 161b formed on the first inner insulator exposed portion receiving groove 10b of the first cable holder 100. At this time, the gripping conductor extension 150b is engaged with the cut 342b of the second contact element 340b.

FIG. 6 shows a state that the central conductors 12a and 12b are engaged with the cuts 332a and 332b of the first contact elements 330a and 330b respectively, and the gripping conductor extensions 150a and 150b are engaged with the cuts 342a and 342b of the second contact elements 340a and 340b respectively.

FIG. 7 shows a coaxial cable harness unit 500 that is completed by having the cable holder assembly 400 engaged with the housing 300. The coaxial cable harness unit 500 completed in this way is coupled with a connector of other cable or a connector provided in the device having terminals that are complementarily engaged with the external cable connection terminals 370a, 370b, 380a, and 380b within a connection chamber (not shown) of the housing 300.

The coaxial cable connector and the coaxial cable harness unit according to the present invention have been explained above. While the two coaxial cables are fitted, the routes from the respective signal transmission central conductors till the external cable connection terminals for the central conductors are disposed on the insulating resin material so that the routes are insulated. At the same time, the routes from the respective outer conductors till the external cable connection terminals for the outer conductors are also disposed on the insulating resin material so that the routes are insulated. As the outer conductors are not coupled together, it is possible to maintain the independence of the outer conductors. Therefore, even when the potential of one outer conductor becomes abnormal, this abnormal condition is not transmitted to all the other outer conductors.

### EFFECTS OF THE INVENTION

In the coaxial cable embodiments according to the inventions described herein, it is possible to easily fit the coaxial cable by engagement based on pressing, and the central conductor and the outer conductor of the coaxial cable are connected to external cable connection terminal in an insulated condition. Therefore, even when a plurality of coaxial cables are fitted, it is possible to separately secure individual shieldings.

In coaxial cable harness embodiments described herein, a coaxial cable harness unit that utilizes any one of the above coaxial cable connectors is provided. Therefore, it is possible to easily connect the connector to the cable, and it is possible to secure excellent shields.

### BRIEF DESCRIPTION OF THE DRAWINGS

FIG. 1 is a perspective view that shows a structure of a coaxial cable connector having a first cable holder, a second cable holder, and a housing, according to the present invention.

FIG. 2 shows a state of end portions of coaxial cables that are connected to the coaxial cable connector shown in FIG. 1.

FIG. 3 shows gripping conductors and gripping conductor extensions that are fitted to the inside of the first cable holder.

FIG. 4 shows contact elements, contact element connection members, and external cable connection terminals that are fitted to the housing.

FIG. 5 shows a cable holder assembly that is the engagement of the first cable holder and the second cable holder, and the housing.

FIG. 6 shows a state that the contact elements, inner insulator exposed portions of the coaxial cables, and the gripping conductor extensions are engaged together.

FIG. 7 shows a state that the cable holder assembly is engaged with the housing.

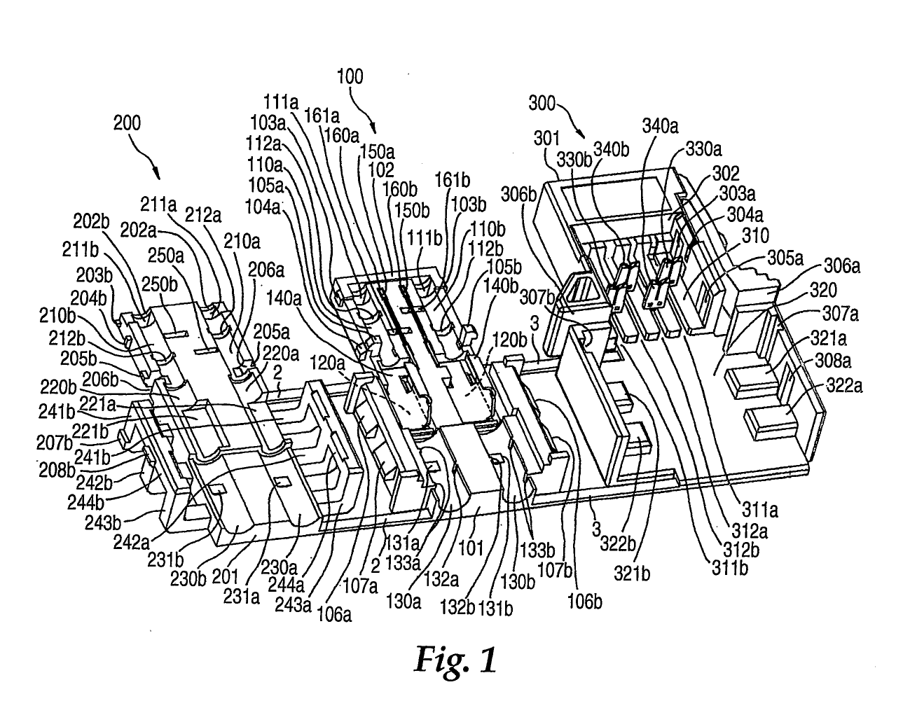

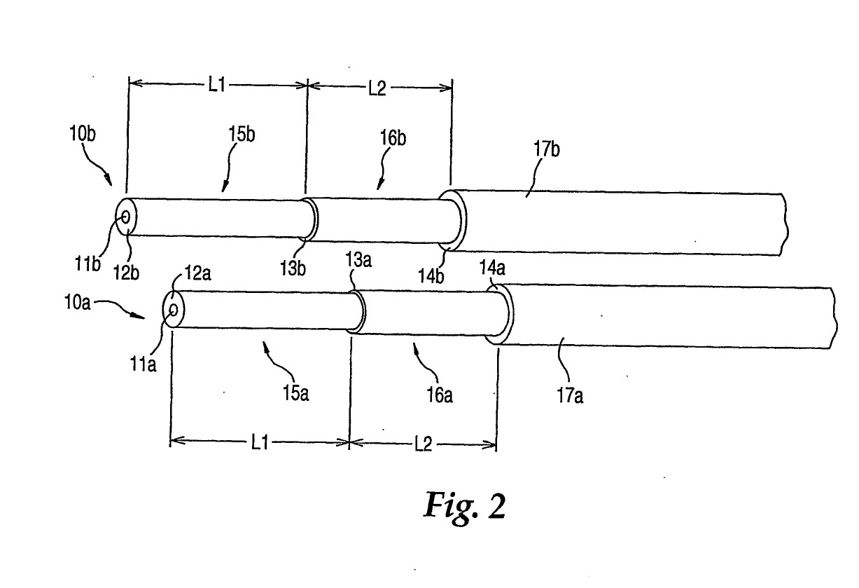

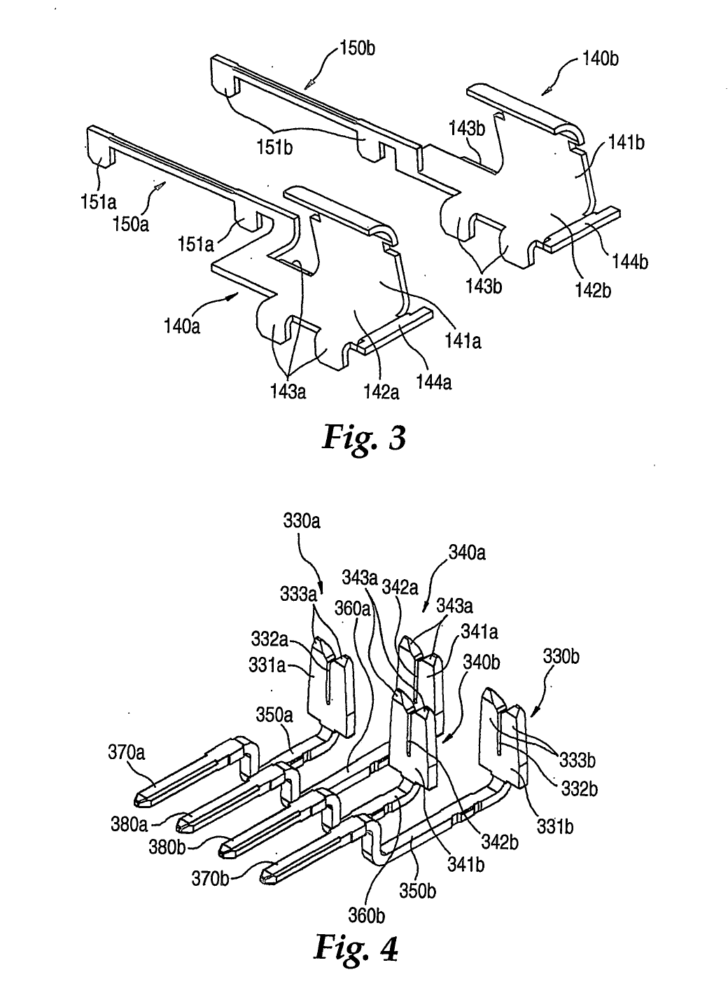

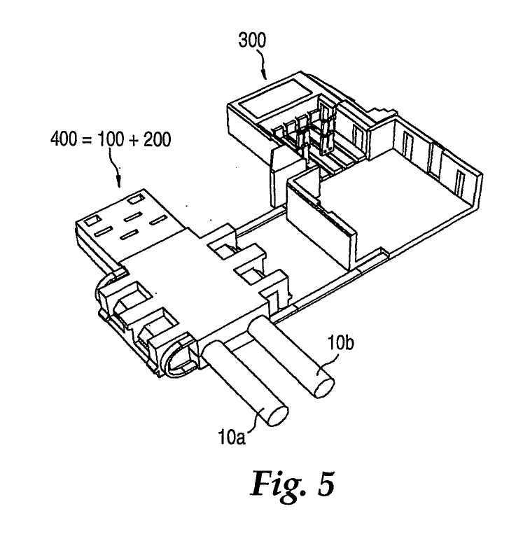

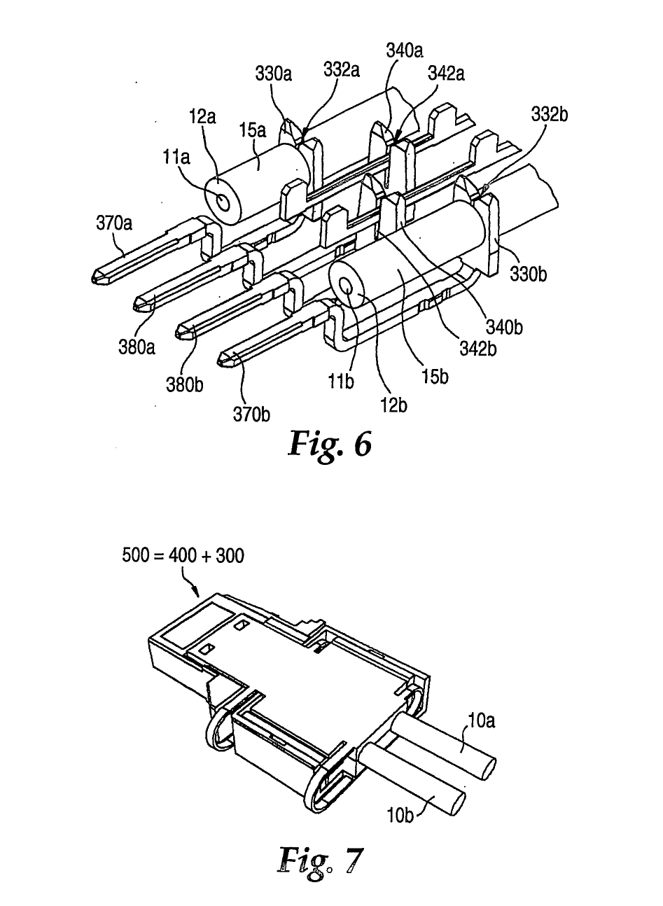

### EXPLANATION OF SYMBOLS

1 . . . coaxial cable connector
2, 3 . . . connection members
10a, 10b . . . coaxial cables
11a, 11b . . . central conductors
12a, 12b . . . inner insulating members
13a, 13b . . . outer conductors
14a, 14b . . . outer insulating members
15a, 15b . . . inner insulator exposed portions
16a, 16b . . . outer conductor exposed portions
17a, 17b . . . original-diameter end portions
100 . . . first cable holder
101 . . . block body
102 . . . front end wall
103a, 103b . . . first projections
104a, 104b . . . second projections
105a, 105b . . . third projections
106a, 106b . . . fourth projections
107a, 107b . . . fifth projections
110a, 110b . . . first inner insulator exposed portion receiving grooves
111a, 111b . . . confirmation holes
112a, 112b . . . (first contact element hole) through-holes
120a, 120b . . . first outer conductor exposed portion receiving grooves
130a, 130b . . . first original-diameter end portion receiving grooves
131a, 131b . . . bottom projections
132a, 132b . . . first side projections
133a, 133b . . . second side projections
140a, 140b . . . gripping conductors
141a, 141b . . . pressed members
142a, 142b . . . base portions
143a, 143b . . . projections
144a, 144b . . . (staged) projections
150a, 15b . . . gripping conductor extensions
151a, 51b . . . projections
160a, 160b . . . gripping conductor extension receiving grooves
161a, 61b . . . (second contact element) through-holes
200 . . . second cable holder
201 . . . block body
202a, 202b . . . front end walls
203a, 203b . . . first projection
204a, 204b . . . second projection
205a, 205b . . . third projection
206a, 206b . . . cuts
207a, 207b . . . fourth projection
208a, 208b . . . fifth projection
210a, 210b . . . second inner insulator exposed portion receiving grooves
211a, 211b . . . confirmation holes
212a, 212b . . . (first contact element) through-holes
220a, 220b . . . second outer conductor exposed portion receiving grooves
221a, 221b . . . gripping conductor clearance grooves
230a, 230b . . . first original-diameter end portion receiving grooves
231a, 231b . . . bottom projections
241a, 241b . . . first arms
242a, 242b . . . second arms
243a, 243b . . . third arms
244a, 244b . . . bars
250a, 250b . . . (gripping conductor extension) through-holes
300 . . . housing
301 . . . block body
302 . . . end wall
303a, 303b . . . first grooves
304a, 304b . . . second grooves
305a, 305b . . . third grooves
306a, 306b . . . cuts
307a, 307b . . . fourth grooves
308a, 308b . . . fifth grooves
310 . . . first chamber
311a, 311b . . . grooves
312a, 312b . . . grooves
320 . . . second chamber
321a, 321b . . . projections
322a, 322b . . . projections
330a, 330b . . . first contact elements
332a, 332b . . . cuts
333a, 333b . . . cutting edges
340a, 340b . . . second contact elements
342a, 342b . . . cuts
343a, 343b . . . cutting edges
350a, 350b . . . connection members
360a, 360b . . . connection members
370a, 370b . . . external cable connection terminals
380a, 380b . . . external cable connection terminals
400 . . . cable holder assembly
500 . . . coaxial cable harness unit

What is claimed is:

1. A coaxial cable connector comprising:
a first cable holder;
a second cable holder which can be engaged to said first cable holder by pressing;
a housing to which an assembly made by engaging of said first cable holder and said second cable holder can be engaged;
at least one gripping conductor and gripping conductor extension extending therefrom which are located in said first cable holder in an insulated condition; and,
a plurality of contact elements and external cable connection terminals connected thereto which are located in said housing in an insulated condition,
wherein,
each cable holder has grooves for receiving an inner insulator exposed portion and an outer conductor exposed portion of a coaxial cable formed at one end thereof,
said gripping conductor each grips said outer conductor exposed portion of the coaxial cable, and
said gripping conductor extensions each engages with corresponding contact element, and a central conductor of the coaxial cable in the outer conductor exposed portion engages with corresponding contact element.

2. A coaxial cable connector according to claim 1, wherein said first cable holder comprises:
a block body;
at least one first inner insulator exposed portion receiving grooves that is formed on a first surface of the block body and receives approximately half of a cross-sectional portion of the inner insulator exposed portion of the coaxial cable;
at least one first outer conductor exposed portion receiving grooves that is formed to continue from a rear end of the first inner insulator exposed portion receiving groove and receives approximately half of a cross-sectional portion of the outer conductor exposed portion of the coaxial cable;
at least one first original-diameter end portion receiving grooves that is formed to continue from a rear end of the first outer conductor exposed portion receiving groove, and receives approximately half of a cross-sectional portion of an original-diameter end portion;
wherein, said gripping conductor is disposed in the first outer conductor exposed portion receiving groove, and said gripping conductor extension extends from said gripping conductor to a direction of the front end of the coaxial cable in parallel with the first outer conductor exposed portion receiving groove,
said second cable holder comprises:
a block body;
at least one second inner insulator exposed portion receiving grooves equal in number to the number of the first inner insulator exposed portion receiving groove of the first cable holder, that is formed on a first surface of the block body and receives approximately half of a cross-sectional portion of the inner insulator exposed portion of the coaxial cable;
at least one second outer conductor exposed portion receiving grooves that is formed to continue from a rear end of the second inner insulator exposed portion receiving groove and receives approximately half of a cross-sectional portion of the outer conductor exposed portion of the coaxial cable; and
at least one second original-diameter end portion receiving grooves that is formed to continue from a rear end of the second outer conductor exposed portion receiving groove, and receives approximately half of a cross-sectional portion of the original diameter portion of the coaxial cable,
wherein, after positioning the outer conductor exposed portion of the coaxial cable to be matched with a position of the gripping conductor of the first cable holder, the first surface of the first cable holder being pressed against the first surface of the second cable holder to face each other so that they are engaged with each other and the second outer conductor exposed portion receiving groove presses the gripping conductor in deformation and thereby grip the outer conductor exposed portion of the coaxial cable, said housing comprises:
a block body, to which said assembly by engaging said first cable holder and said second cable holder are engaged by pressing;
at least one first contact elements equal in number to the number of the first inner insulator exposed portion receiving groove of the first cable holder, mounted on a first surface of the block body and is capable of engaging with the central conductor of the inner insulator exposed portion of the coaxial cable at the engagement time; and
at least one second contact elements equal in number to the number of the first inner insulator exposed portion receiving groove of the first cable holder, mounted on the first surface of the block body and is capable of engaging with the gripping conductor extension that is disposed on the first cable holder upon engagement,
wherein, said first contact element being connected to an insulated external cable connection terminal for the central conductor via an insulated connection member for said first contact element, and said second contact element being connected to an insulated external cable connection terminal for the outer conductor via an insulated connection member for said second contact element,
wherein, said first cable holder and said second cable holder are fitted with complementary engaging units respectively for mutually engaging the two cable holders, and at least one of the first cable holder and the second cable holder, and the housing are provided with complementary engaging units respectively for mutually engaging the cable holder assembly and the housing.

3. The coaxial cable connector according to claim 2, wherein the first contact element and the second contact element have cuts formed on plate members that are mounted on the block body of the housing respectively.

4. The coaxial cable connector according to claim 1, wherein the gripping conductor extension has projections that stretch perpendicularly in a longitudinal direction, and the projections are engaged with holes formed on the first cable holder, and are held at predetermined positions.

5. The coaxial cable connector according to claim 1, wherein the gripping conductor has projections that stretch perpendicularly in a longitudinal direction, and the projections are engaged with holes formed on the first cable holder, and are held at predetermined positions.

6. The coaxial cable connector according to claim 1, wherein the gripping conductor has a pressed portion that is pressed and deformed, and a base portion to which one side of the pressed portion is integrally connected, the gripping conductor extension is connected to a first end of the base portion near the front end of the coaxial cable, and staged projections that bite into the original-diameter end portion and are capable of gripping the original-diameter portion are formed on a second end of the base portion far from the front end of the coaxial cable.

7. A coaxial cable harness unit that is formed by using any one of the coaxial cable connectors according to claim 1.
